(19) United States
(12) Patent Application Publication
(10) Pub. No.: US 2013/0185156 A1
(43) Pub. Date: Jul. 18, 2013

(54) COMMUNICATION DEVICE AND MESSAGE MANAGEMENT METHOD

(71) Applicant: ZHONG-LIN XU, Shenzhen City (CN)

(72) Inventor: ZHONG-LIN XU, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/422,149

(22) Filed: Mar. 16, 2012

(30) Foreign Application Priority Data
Jan. 13, 2012 (CN) 201210009473.9

(51) Int. Cl. G06Q 30/02

(52) U.S. Cl. 705/14.61

(57) ABSTRACT

In a message management method of a communication device, a plurality of keywords relating to different commercial activities are preset and stored into a keyword database. Whether a received message of the communication device is an advertisement of a commercial activity is determined by comparing content of the message with each keyword of the keyword database. A starting time of the commercial activity is extracted from the message if the message is an advertisement. An pre-activity alarm time is determined according to the extracted starting time, and an alarm is given to a user when the alarm time is reached.

### BACKGROUND

1. Technical Field

Embodiments of the present disclosure relate generally to information management technologies, and particularly to a communication device and a message management method of the communication device.

2. Description of Related Art

Mobile phones and other electronic devices provide a short message service (SMS) that allows for text or image based communications. Many department stores and other places may promote their goods by sending advertisements announcing scheduled commercial activities (e.g., shopping promotions, and shopping discounts) using SMS to people. However, a user may easily forget the scheduled commercial activities after skimming through a large number of advertisements, which may decrease the effectiveness of the advertisement.

### BRIEF DESCRIPTION OF THE DRAWINGS

FIG. 1 is a schematic block diagram illustrating one embodiment of a communication device comprising a message management system.

FIG. 2 is a schematic diagram of the display of a dialog box as an example of notifying a user of a commercial activity.

FIG. 3 is a flowchart of one embodiment of a message management method of the communication device of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

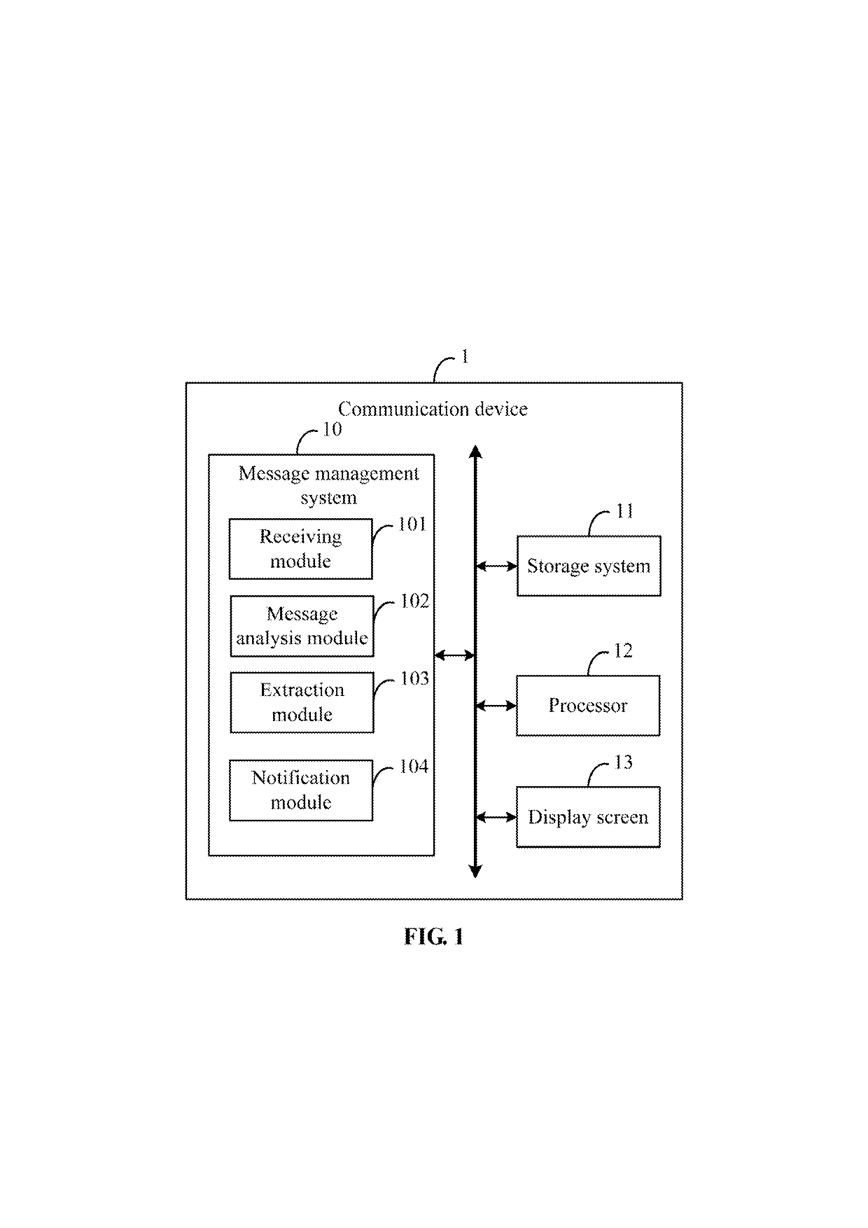

FIG. 1 is a schematic diagram illustrating one embodiment of a communication device 1 comprising a message management system 10. In the embodiment, the communication device 1 further includes a storage system 11, a processor 12, and a display screen 13. In one embodiment, the communication device 1 may be, for example, a mobile phone or a personal digital assistant (PDA). FIG. 1 is only one example of the communication device 1, the communication device 1 can include more or fewer components than those shown in the embodiment, or have a different configuration of the components.

The message management system 10 may include a plurality of programs in the form of one or more computerized instructions stored in the storage system 11 and executed by the processor 12 to perform operations of the communication device 1. In the embodiment, the message management system 10 includes a receiving module 101, a message analysis module 102, an extraction module 103, and a notification module 104. In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

The receiving module 101 receives one or more user input keywords relating to different commercial activities, and stores the keywords into a keyword database that is stored in the storage system 11. The keywords may be received from an input/output device such as a keyword or a touch screen of the communication device 1, and the user may use the input/output device to input the keywords. In one embodiment, the commercial activities may include, for example, promotions for shoppers, and discounts for shoppers, which may be offered by department stores or similar organizations. Each of the preset keywords may include single words and phrases, for example, “promotion”, “on sale”, “prepay discount” and “shopping discount”. In another embodiment, the keyword database may include one or more default keywords preset by the manufacturer of the communication device 1.

The message analysis module 102 determines whether any message received by the communication device 1 is an advertisement of a commercial activity. In one embodiment, the message may be a short message (SMS), and the communication device 1 may receive the message from other terminal communication devices through a wireless communication network, such as the GSM communication network or the WCDMA communication network. When the message is received by the communication device 1, the message analysis module 102 may compare content of the message with each keyword in the keyword database, and determine whether the received message is an advertisement as a result of the comparison. For example, if the content of the received message includes at least one keyword of the keyword database, the received message is determined to be an advertisement of a commercial activity. If none keyword of the keyword database is contained in the received message, the received message is determined to be not an advertisement.

The extraction module 103 extracts a starting time of the commercial activity from the received message if the received message is determined to be an advertisement. “Starting time” is the calendar and/or time information when the commercial activity is to commence or be available. In one example, the extraction module 103 may extract time information from the received message according to particular time formats, such as, “Y-M-D”, “Y/M/D”, and “Y.M.D”, in which “Y” represents year, “M” represents month, and “D” represents day. In one embodiment, the extracted time information may be a particular time which is to be the starting time of the commercial activity where no closing time information is given. In another embodiment, the extracted time information may be a period of time between two particular time points where the commercial activity is temporary, and the beginning of such period of time is regarded as the starting time of the commercial activity.

The notification module 104 determines the time at which an alarm or warning (herein after “alarm time”) should be given to the user in relation to the commercial activity depending on the extracted starting time of the commercial activity. For example, the alarm time may be determined to be 12 hours, 24 hours, or 48 hours before the starting time of the commercial activity. When the alarm time of the commercial activity is reached, the notification module 104 notifies or reminds the user of the communication device 1 about the commercial activity. In one example, the notification module 104 may generate a ringtone or a vibration of the communication device 1 to notify or remind the user.

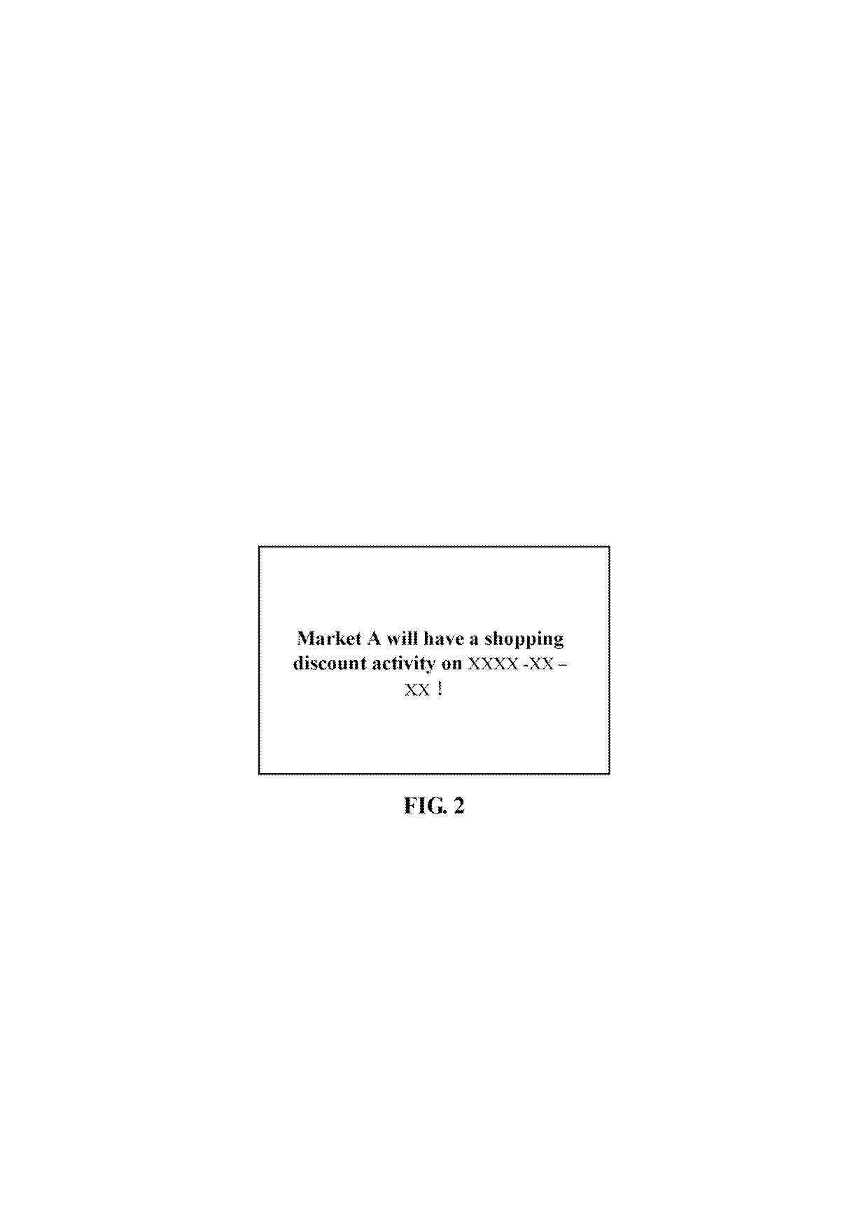

In addition, the notification module 104 may display a dialog box on the display screen 13 of the communication device 1 when the ringtone is generated, and display information as to the commercial activity in the dialog box. The relevant information may be obtained from the received message that announces the commercial activity. In one example, as shown in FIG. 2, if the commercial activity is a discount at market A, the notification module 104 displays the relevant information of the shopping discount activity in the dialog box.

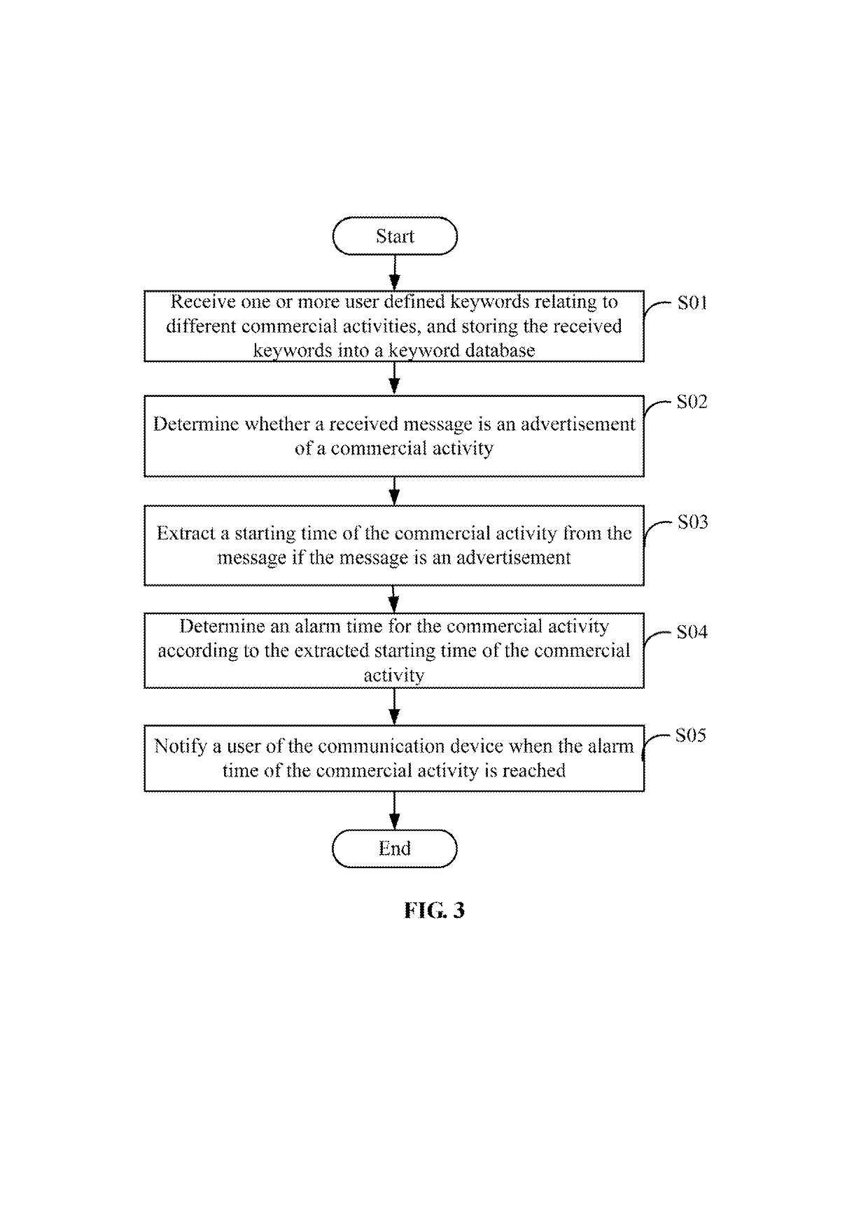

FIG. 3 is a flowchart of one embodiment of a message management method of the communication device 1 of FIG. 1. Depending on the embodiment, additional blocks may be added, others removed, and the ordering of the blocks may be changed.

In step S01, the receiving module 101 receives one or more user input keywords relating to different commercial activities, and stores the keywords into the keyword database.

In step S02, when the communication device 1 receives a message, the message analysis module 102 determines whether the received message is an advertisement of a commercial activity. In one embodiment, the message analysis module 102 may compare content of the message with each keyword in the keyword database, and determine whether the received message is an advertisement as a result of the comparison.

In step S03, the extraction module 103 extracts a starting time of the commercial activity from the received message if the received message is an advertisement.

In step S04, the notification module 104 determines an alarm time for the commercial activity according to the extracted starting time of the commercial activity. For example, the alarm time may be determined to be necessary 12 hours, 24 hours, or 48 hours before the starting time of the commercial activity.

In step S05, when the alarm time of the commercial activity is reached, the notification module 104 notifies or reminds the user about the commercial activity. In one example, the notification module 104 may generates a ringtone or a vibration of the communication device 1 to notify the user. Furthermore, the notification module 104 may display a dialog box (e.g., the dialog box of FIG. 2) on a display screen of the communication device 1 simultaneously with the ringtone, and display relevant information of the commercial activity in the dialog box. The relevant information may be obtained from the received message.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A message management method of a communication device, the communication device comprising a keyword database that stores keywords related to commercial activities, the method comprising:
determining whether a received message of the communication device is an advertisement of a commercial activity by comparing content of the message with each keyword of the keyword database, when the message is received by the communication device;
extracting a starting time of a commercial activity from the message if the message is an advertisement of the commercial activity;
determining an alarm time for the commercial activity according to the extracted starting time of the commercial activity; and
notifying a user of the communication device when the alarm time of the commercial activity is reached.

2. The method according to claim 1, further comprising:
receiving one or more user input keywords relating to the commercial activities, and storing the received keywords into the keyword database;

3. The method according to claim 1, wherein the keyword database comprises one or more default keywords that are preset by a manufacture of the communication device.

4. The method according to claim 1, wherein the notifying step comprises:
generating a ringtone or a vibration of the communication device to notify the user.

5. The method according to claim 1, wherein the notifying step comprises:
displaying a dialog box on a display screen of the communication device, and displaying information as to the commercial activity in the dialog box.

6. A communication device, comprising:
a storage system;
a database stored in the storage system that stores keywords related to commercial activities;
at least one processor;
one or more programs stored in the storage system and executed by the at least one processor, the one or more programs comprising:
a message analysis module that determines whether a received message of the communication device is an advertisement of a commercial activity by comparing content of the message with each keyword in the keyword database, when the message is received by the communication device;
an extraction module that extracts a starting time of a commercial activity from the message if the message is an advertisement of the commercial activity; and
a notification module that determines an alarm time for the commercial activity according to the extracted starting time of the commercial activity, and notifies a user of the communication device when the alarm time of the commercial activity is reached.

7. The communication device according to claim 6, wherein the one or more programs further comprises:
a receiving module that receives one or more user input keywords relating to the commercial activities, and stores the received keywords into the keyword database;

8. The communication device according to claim 6, wherein the keyword database comprises one or more default keywords that are preset by a manufacture of the communication device.

9. The communication device according to claim 6, wherein the notification module further generates a ringtone or a vibration of communication device to notify the user.

10. The communication device according to claim 6, wherein the notification module further displays a dialog box on a display screen of the communication device, and displays information as to the commercial activity in the dialog box.
